(19) United States
(12) Patent Application Publication
(10) Pub. No.: US 2005/0242263 A1
(43) Pub. Date: Nov. 3, 2005

(54) Rotatable display apparatus

(75) Inventors: Wallace A. Krapf, Macedon, NY (US); Daniel W. Rossborough SR., Victor, NY (US)

Correspondence Address: WALL MARJAMA & BILINSKI, 101 SOUTH SALINA STREET, SUITE 400, SYRACUSE, NY, 13202, US

(73) Assignee: W.A. Krapf, Inc., Macedon, NY (US)

(21) Appl. No.: 11/101,710

(22) Filed: Apr. 8, 2005

Related U.S. Application Data
(63) Continuation-in-part of application No. 10/834,296, filed on Apr. 28, 2004.

(51) Int. Cl. G09G 5/00; F16M 13/00

(52) U.S. Cl. 248/415

(57) ABSTRACT

A compact display apparatus includes a stationary base and a support mounted to a top surface of the stationary base. A vertically extending member is disposed through the interior of each of the support and the base along a center axis, thereby permitting selective rotation of the support. The support includes a plurality of lateral side panels for displaying graphic and or other materials, such as photographs and advertising wherein the apparatus can be used on a table-top or similar surface. The apparatus can further include a handle to facilitate transport.

### CROSS REFERENCE TO RELATED APPLICATION

The following application claims priority under 35 USC 120 as a continuation-in-part application of commonly owned U.S. Ser. No. 10/834,296, entitled ROTATABLE DISPLAY APPARATUS, filed Apr. 28, 2004.

### FIELD OF THE INVENTION

This invention relates to the field of displaying articles, and more specifically to a portable rotatable display apparatus capable of displaying or supporting a plurality of graphic and other media and/or advertising materials.

### BACKGROUND OF THE INVENTION

A number of varied forms of display are presently known upon which graphic media materials such as articles, photographs, and other textual and/or pictorial items, can be displayed or presented. Such displays have proven useful for groups or gatherings including, for example, weddings, bowling and golf tournaments and leagues, tradeshows, seminars, corporate functions and outings, and the like. These displays typically include a single planar facing surface onto which any of the above items can be affixed, thereby taking up a considerable amount of floor space. Such displays, to date, include apparatus such as bulletin boards and the like. Similar displays, used for example, for advertising or for functional purposes, such as scheduling or calendaring, among others. The issues relating to available floor space equally pertain to each of the above displays.

There is a need to maximize display space in as small an area as possible.

### SUMMARY OF THE INVENTION

It is therefore a general need in the field and an object of the present invention to provide an improved apparatus for purposes of displaying multiple media articles, such as photographs, and the like.

It is a further object of the present invention to provide a display apparatus that is easier and less complex to manufacture than previously known apparatus of this type.

It is a further object to provide an extremely compact display apparatus that can be easily moved from location to location and which maximizes available display space in a relatively small footprint.

It is yet a further object of the present invention to provide a display apparatus that permits illumination and other electrically powered components to be added without significant modification or expense to the apparatus.

It is yet another object of the invention to provide a compact display which permits a user to easily position the apparatus without significant space requirements and which permits easy storage and use.

Therefore and according to a preferred aspect of the present invention, there is disclosed a compact display apparatus for graphic and other media materials, said display apparatus comprising:
a base; and
a support rotatably mounted to said base, said support including at least one display panel having means for receiving a plurality of photographs and other graphic media, said display apparatus being sufficiently compact to fit on a table top.

In one version, the apparatus further includes at least one vertically extending member disposed through the interior of the base and support along a center axis, the at least one vertically extending member being supported to said support and said base at either end thereof to permit said support to be rotatable.

According to another version, the base can include a turntable or other means which is secured to the support to enable rotation thereof.

According to one version of the present invention, the vertically extending member includes means for routing or otherwise supporting a number of electrical leads such as, for example, those extending from a power supply, permitting the inclusion of at least one lamp, LED or other light source at the top or other convenient part of the support. According to another version, a sign or marquee, can be separately attached to the top of the display apparatus, the sign or marquee having at least one illuminated portion thereof for advertising or other purposes that can be energized by means of the above lead connection. According to one version, the vertically extending member includes at least one slot or is formed as a hollow component in order to permit the passage of the electrical leads therethrough. Alternatively, the illuminated sign or marquee can be placed elsewhere on the herein described display apparatus, such as within the base, or separately affixed to the support or other portions of the display apparatus.

The herein described display apparatus can further include at least one electric motor, preferably housed within the confines of the base, for selectively rotating the support, as needed, and/or supply power to enable illumination.

The base of the herein described display apparatus is stationary and is preferably made from a lightweight plastic material that can be formed or molded into a unitary member, thereby simplifying manufacture. Additionally, the base can be made from a translucent or colored material to permit light transmission, for example, backlighting.

An advantage of the present invention is that a display apparatus is provided that can be conveniently placed upon or supported by a table top with a minimum footprint.

The display apparatus further includes a handle and is lightweight, making the apparatus portable and versatile.

Yet another advantage of the present invention is that multiple sides of the display apparatus can be viewed at once.

Another advantage of the present invention is that a number of different display panels can be selectively rotated, either manually or automatically, each of the panels wherein, depending on the design, can include the same or differing means for supporting different forms of graphic media material. The support can also preferably assume a number of geometric configurations. According to the herein described embodiments, the support is cubic in configuration, containing four (4) lateral or side display panels, but it should be understood that the number and size of the panels can easily be varied, depending on the application. Furthemore, it will also become readily apparent that the herein described support and base can assume a variety of shapes such as circular (e.g., cylindrical), rhombic, trapezoidal, triangular, other polyhedral configurations and the like. According to yet another embodiment, the display panels can be directly and separately attached to the vertically extending member wherein the member can comprise a core section having a configuration that permits attachment thereto. For example, the core section can be square or round in cross section.

According to another embodiment, at least one display panel can be separately hinged to the support or directly to the vertically extending member, permitting the panels to open in a leaf-like fashion, and maximizing available display space in a small area.

A further advantage of the present invention is that the display apparatus can be made more efficiently with fewer parts than previously known versions. Moreover, the ability to rout electrical leads through the herein described display apparatus further expands the number of uses thereof.

These and other objects, features and advantages will become readily apparent from the following Detailed Description which should be read in conjunction with the accompanying drawings.

### BRIEF DESCRIPTION OF THE DRAWINGS

FIG. 1 is a front perspective view of a rotatable display apparatus per a first embodiment in accordance with the present invention;

FIG. 2 is a partially exploded view of the rotatable display apparatus of FIG. 1;

FIG. 3 is a sectioned view illustrating the attachment of the vertically extending member relative to the top of the support of the rotatable display apparatus of FIGS. 1 and 2;

FIG. 4 is an exploded view illustrating the attachment of the vertically extending member relative to the base of the display apparatus of FIGS. 1 and 2;

FIG. 5 is a front perspective view of a rotatable display apparatus made in accordance with a second embodiment of the present invention;

FIG. 6 is a front perspective view of a rotatable display apparatus made in accordance with a third embodiment of the present invention;

FIG. 7 is a rotated front perspective view of the rotatable display apparatus of FIG. 6;

FIG. 8 is a bottom view of the rotatable display apparatus of FIGS. 6 and 7;

FIG. 9 is a top perspective view of a graphic media materials carrier panel that can be used for the display apparatus; and

FIG. 10 is an exploded view of the graphic media materials carrier panel of FIG. 9.

### GENERAL DESCRIPTION OF INVENTION

The following description relates to a number of specific embodiments of a rotatable display apparatus made in accordance with aspects of the present invention. Throughout the discussion that follows a number of terms are used such as “top”, “bottom”, “lateral”, “side” and the like. It should be noted that these terms are not intended to limiting of the present invention, except where specifically indicated otherwise and are intended merely to provide a frame of reference with regard to the accompanying drawings.

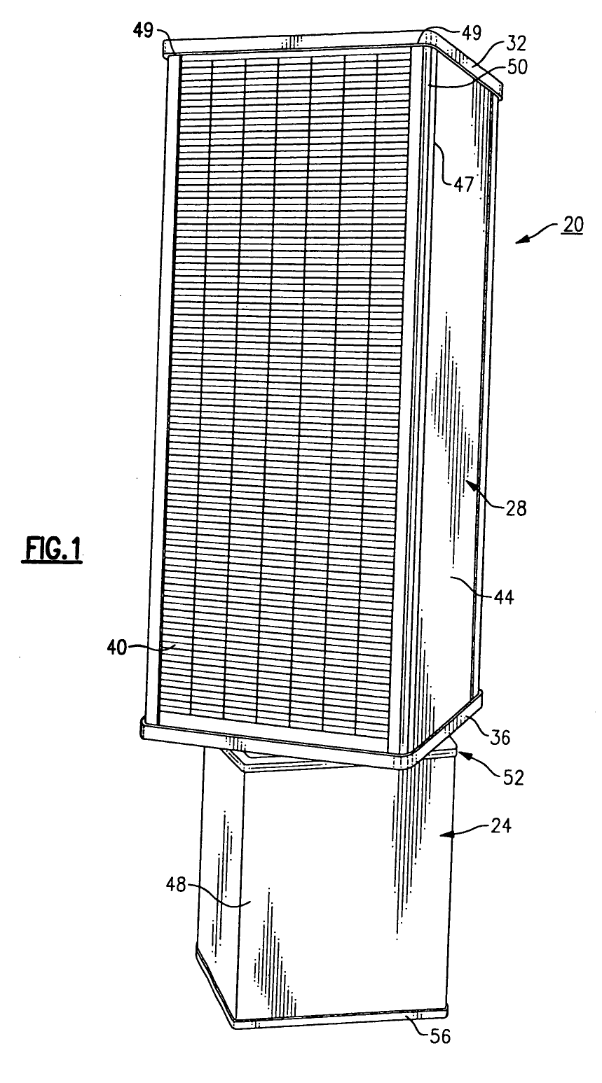

Referring to FIGS. 1-4, the rotatable display apparatus 20 according to the first embodiment is defined by two primary components, namely a stationary or fixed base 24 and a support 28 that is mounted onto the top of the stationary base, the support being supported for rotation thereupon about a center axis, as described in greater detail below.

The support 28, according to this specific embodiment, is substantially cubic in terms of configuration having an overall aspect ratio in terms of height to width of approximately 4:1, though it will be readily apparent from the discussion that follows that this parameter can be selectively varied, depending, for example, on the application or intended use. According to the present embodiment, the support 28 is approximately 76″ (inches) in height and approximately 19″ in width. The support 28 is defined by a pair of covers; namely a top cover 32 and a bottom cover 36, as well as four lateral or facing side panels (only two of the panels 40, 44 being shown) that enclose a hollow interior. Additionally, the number of facing side panels 40, 44 used in the support 28 can be suitably varied, meaning that the support 28 can also assume a varied number of shapes or design configurations. For example, the support 28 can be polyhedral, thereby having any convenient number of sides, or alternatively can also be circular. Though the latter configuration does not necessarily provide for large savings in storage space, a circular configuration, for example, may be more useful, however, for advertising purposes.

In the present embodiment, the total display space taken by the facing side panels 40, 44 is approximately equivalent to that of a 4′×6′ board display, while being situated in a floor space of 23″×23″; that is, the diameter of a circle that is formed by the rotating support 28.

Each of the side panels 40, 44 are attached to one another by means at the corners thereof by means of a corresponding plurality of connection brackets 47, each of the connection brackets having a pair of laterally extending slots 49 situated at right angles to one another at respective ends for permitting the attachment to the edges of interconnecting side panels 40, 44. The ends of each of the connection members 47 are received within the confines of the top and bottom cover 32, 36, respectively. The connection brackets 47 further provide an inwardly cupped portion 50, along the length thereof, enabling the support 28 to be easily rotated by the user, the inwardly cupped portion being sized in order to permit the fingers of the user to easily maintain a stable hold upon the support 28.

The stationary base 24 of the herein described display apparatus 20 according to this embodiment is also preferably defined by a substantially cubic configuration, though having a significantly smaller aspect ratio of about 1.3 to 1 in terms of height to width. It will be readily understood, however, that this parameter, as well as the shape thereof, can also easily be varied. According to the present embodiment, the base 24 has a height of approximately 28 inches. According to this version, a unitary molded plastic section 48 forms each of the side or lateral walls of the base 24, the base also having respective top and bottom covers 52, 56 attached to respective open ends. This unitary section 48, for example, can be made from a translucent material to permit backlighting, as described in greater detail below.

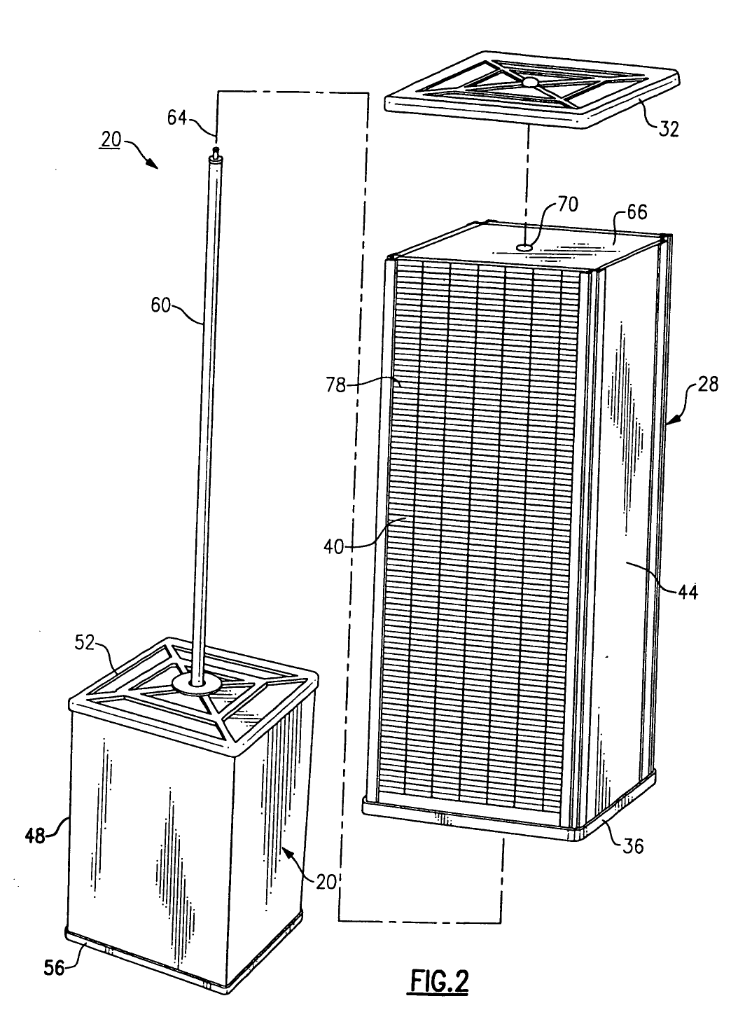

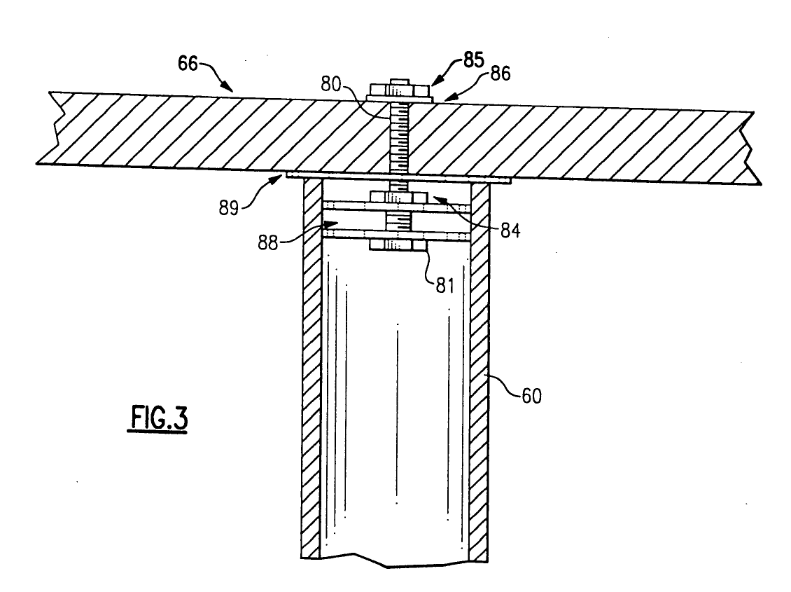

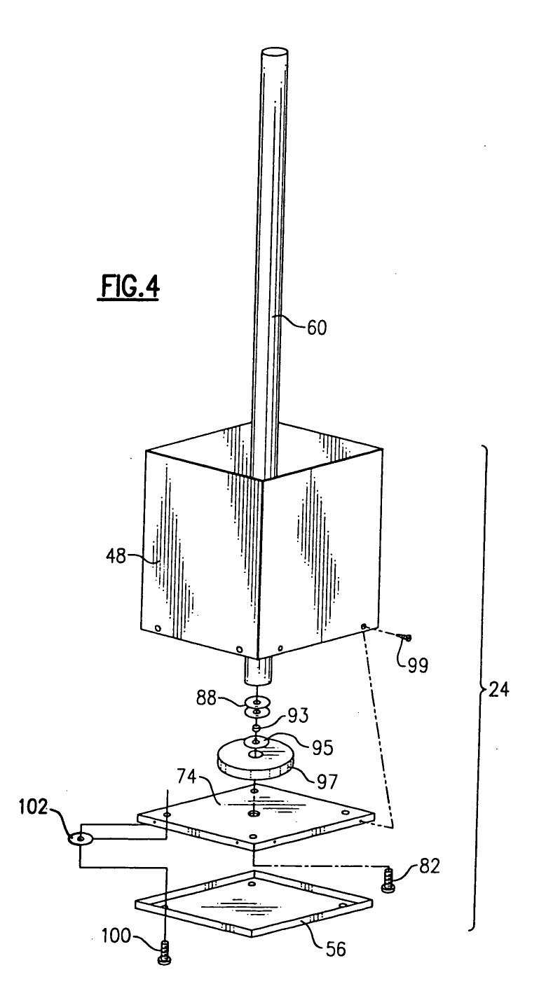

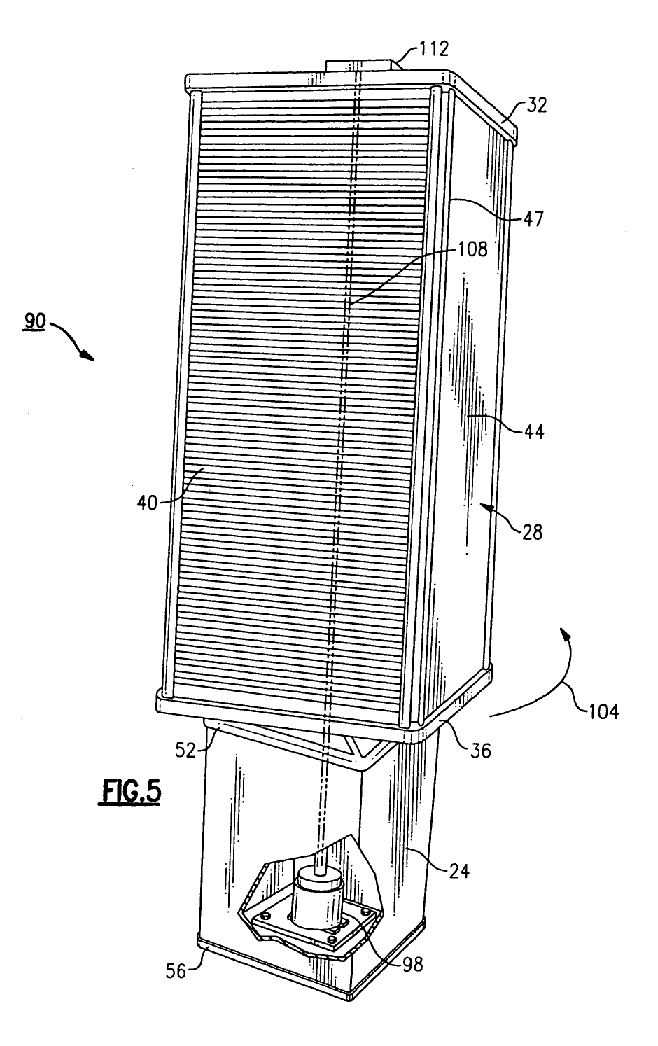

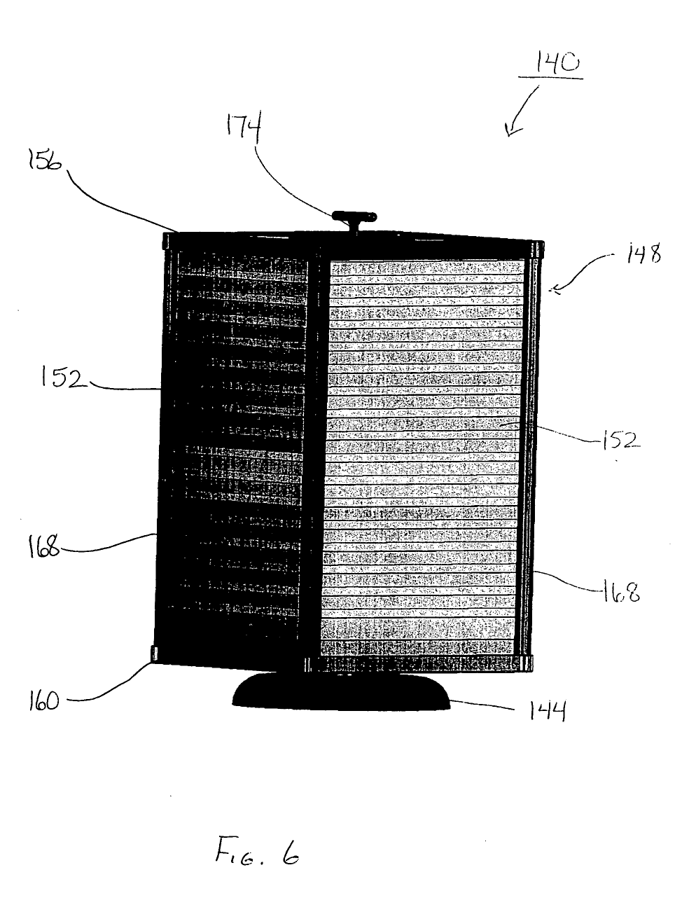

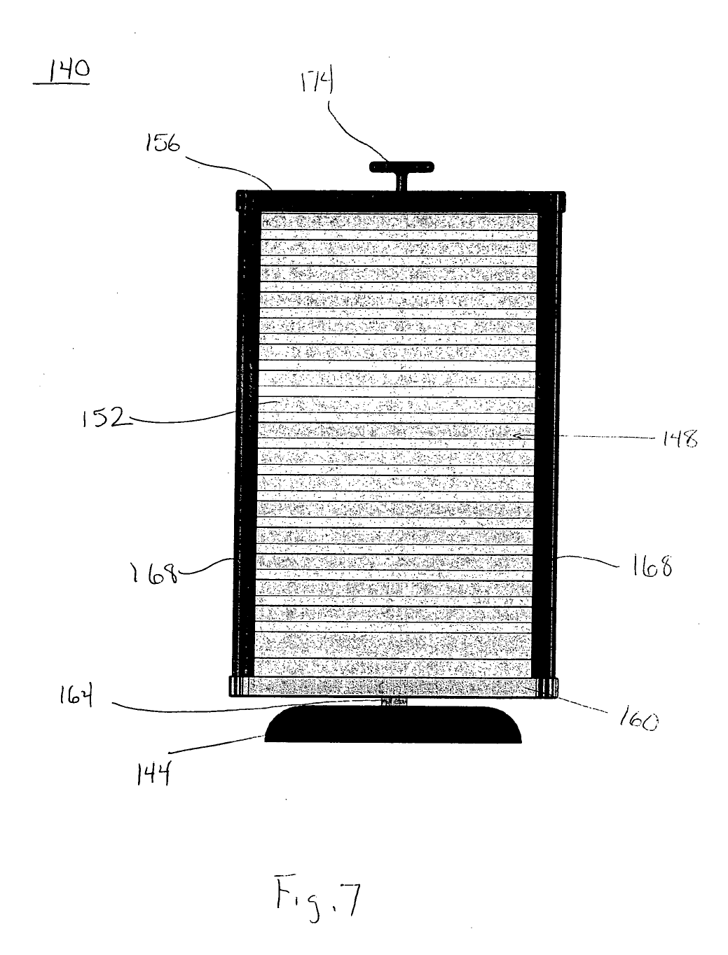

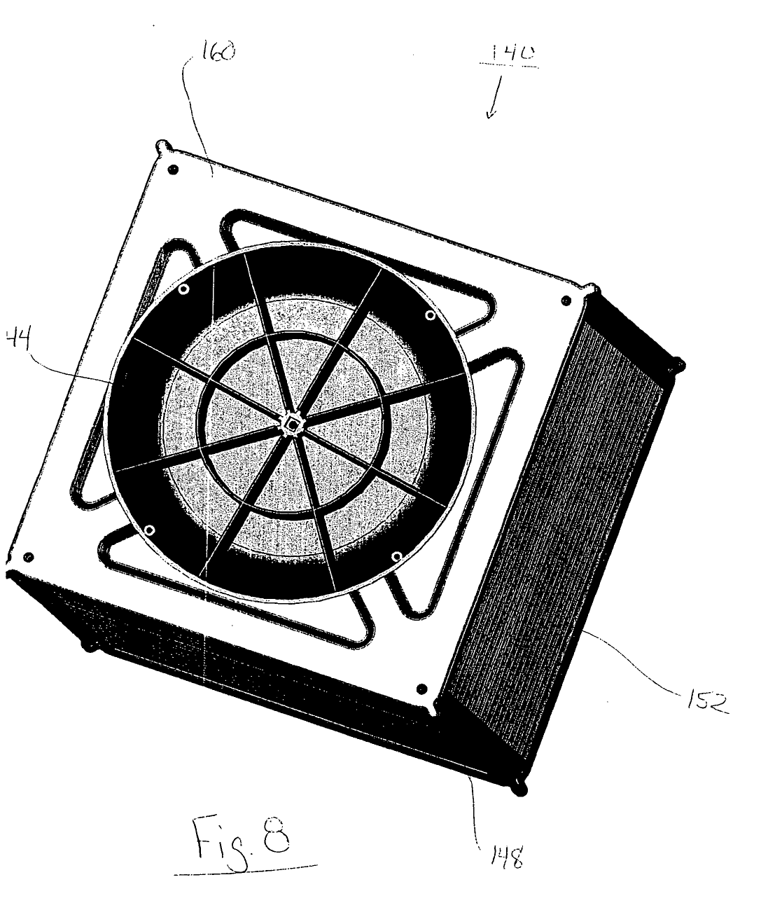

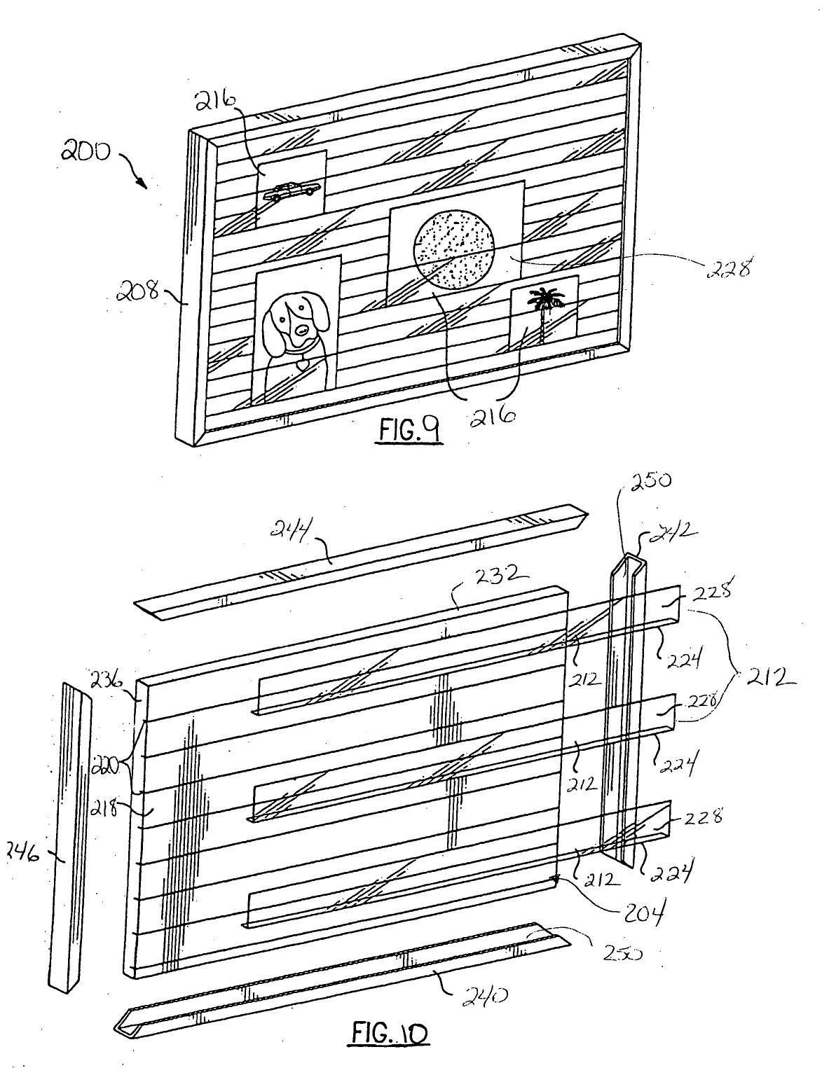

Referring to FIG. 2, the display apparatus 20 further includes a vertically disposed member 60, such as a pole, extending through the hollow interiors of each of the stationary base 24 and the support 28. An intermediate top panel 66, made from wood or other structural material, interposed between the top cover 32 and the hollow interior of the support, distributes the weight of the support 28, wherein a fastener (not shown in this figure) used to connect the vertically disposed member 60 to the support 28 extends through an opening 70. A similar intermediate bottom panel 74, FIG. 4, is provided between the bottom cover 53 of the base 24 and the interior thereof in order to distribute weight effectively and to enable attachment of the vertically extending member 60, as will now be described in greater detail. Alternatively, the top and bottom covers can be fabricated to perform the functions of each of the cover and the intermediate panel.

The vertically extending member 60 is fixedly anchored at each of its opposing ends. This attachment is depicted in FIGS. 2 and 3. More particularly and as shown in FIG. 3, the upper end of the vertically extending member 60 is fitted with an insert 88 defined by a pair of concentric discs, each disc having teeth on its exterior that engage the interior of the vertically extending member when inserted a predetermined length. The insert 88, which is press fitted into the upper end of the vertically extending member, includes a center opening that receives the end of a fastener 80, such as a carriage bolt, or similar fastening means such that the shank of the fastener extends outwardly therefrom and the head 81 of the fastener engages the insert. The fastener 80 is attached to the insert 88 by means of a nut 84 that is tightened thereupon. The shank of the fastener 80 is inserted through the intermediate panel 66 through opening 70 and capped by means of an appropriate nut and washer 86 combination. Preferably, a nylon locking nut 85 is used, the nut being simply engaged sufficiently to provide attachment but not restrict rotation of the support 28. The interface between the intermediate panel and the vertically extending member 60 includes a nylon or similar washer 89 or similar means that is introduced therebetween.

Similarly and referring to the exploded view of FIG. 4, the lower end of the vertically extending member 60 is anchored to the base 24 of the display apparatus 20, FIG. 2. In this instance, a similar insert 88 to that used in the upper end is fitted within the lower end of the vertically extending member 60 and a fastener 82, such as a carriage bolt or similar fastener, is tightened in place. In this instance, the fastener 82 has a sufficiently long shank such that the remaining end of the fastener is fitted through the thickness of the lower intermediate panel 74 and optionally through an opening of an interposed counterweight 97. A corresponding nut 93 and washer 95 combination or similar means, is used to tighten the fastener 82 in place and anchor the vertically extending member 60 and the counterweight 97 within the display apparatus 20. The intermediate lower panel 74 is similarly anchored to the hollow unitary portion 48 of the base 24, in this instance using a plurality of flat head screws 99 mounted to the edges of the panel. Each of the top and bottom covers 32, 56 are attached to a corresponding intermediate panel 66, 74, respectively, by means of fasteners 100 that are inserted through openings in the covers and the panels along with threaded T-nuts 102 (only the bottom cover 56 being shown, see FIG. 4) to retain same, though it will be apparent that other means can be utilized.

When assembled as described above, the base 24 of the herein described display apparatus 20 is fixed, while the support 28 is freely rotatable about its center axis 64, FIG. 2, due to the securement of the vertically extending member 60 at either end to the support 28 and the stationary base 24, respectively.

According to one version, at least one of the facing side panels 40, 44 of the support 28 are capable of supporting various forms of graphic media and/or other forms of materials for display. Referring to FIGS. 9 and 10, an exemplary graphic media carrier panel 200 is shown for use with the herein described apparatus for at least one of the side panels 40, 44.

In this instance, the graphic media carrier panel 200 is defined by a planar supporting member 204, a frame 208 and a plurality of transverse strip members 212 that are used to support a plurality of graphic media materials, such as, for example, a plurality of photographs 216. The planar supporting member 204 is defined by a sufficiently rigid, though preferably a suitably lightweight material, such as foam, plastic or other material and includes a top or upper facing surface 218 having a series of parallel longitudinal slots 220 that have been cut at least partially into the surface. Each of the slots 220 are preferably, though not necessarily, equally spaced from one another and extend transversely relative to the major dimension (in this case, the length) of the member 204. It should be noted in passing, however, that the shape of the supporting member 204, comprising the side panel of the display apparatus, though rectilinear according to this embodiment, can assume square, rounded, or other suitable shapes in accordance with that of the invention. According to this particular embodiment, the longitudinal slots 20 are equally spaced from one another approximately 1.25 inches, though this parameter can also be varied easily depending on the application or intended use of the carrier, and the size of supporting pocket/materials that may be required for display.

The transverse strip members 212 used in conjunction with the carrier panel 200 described herein are flat, elongate, substantially L-shaped sections that are fabricated preferably from a transparent, lightweight plastic material, such as, for example, a rigid vinyl. Each of the strip members 212 are defined by an engagement or supporting portion 224 and a cover portion 228. Preferably, the supporting portion 224 and the cover portion 228 are angled relative to one another to substantially form an L-shape with the cover portions having a length that is substantially larger than the spacing between the slots 220 formed in the planar supporting member 204. According to this specific embodiment, the length of each of the cover portions 228 is approximately 1.875 inches, thereby providing an excess length relative to the spacing between adjacent longitudinal slots 220 of approximately 0.625 inches.

The supporting portion of each transverse strip member 212 is inserted into a corresponding slot of the facing surface 218 of the planar supporting member 204 such that the cover portion 228 extends along an axial portion of the facing Surface in a direction extending “above” the slot 220. The supporting portion 224 is not bent orthogonally relative to the cover portion 228, but rather is set at a slightly obtuse angle, such that upon insertion into the slot the cover portion is angled slightly inwardly toward the facing surface 218 of the planar supporting member 204.

Alternately, the strip members 212 can assume a substantially orthogonal configuration between the cover portion 228 and the supporting portion 224, with the slot 220 being angled relative to the plane defined by the facing surface 218 of the planar supporting member 204.

The frame 208 of the herein-described carrier panel 200 is attached to the edges 232, 236 of the planar supporting member 204 and forms a peripheral border about the panel. The frame 208 can be defined by a single unitary section (not shown) or alternately can be fabricated from separate members 240, 242, 244, 246 that are fitted about the outer periphery of the planar supporting member 204, using fasteners or other conventional means (not shown), each of the frame sections including receiving slots 250 fitted to the respective edge of the supporting member.

Additional description relating to the transparent sleeves and the media carrier display panel referred to above are provided in U.S. Ser. No. 10/732,662, filed Dec. 10, 2003, the entire contents of which are incorporated herein by reference. Another lateral or side panel 44 according to this specific embodiment, is depicted as a bulletin board, though any or all of the lateral side panels can alternatively comprise at least one graphic carrier panel 200, FIG. 9, a white dry-erase board, a calendar board, a magnetic board, or other suitable form of display.

Alternatively, some or all of the lateral side panels do not necessarily have to permit support of graphic media materials and can be used, for example, as advertising or for functional purposes, such as calendaring or scheduling, among others. According to yet another version, at least one of the lateral side panels can open or expand, such as shown in the previously incorporated U.S. Ser. No. 10/732,662 application, in order to further maximize available display space, through a hinged or similar configuration. In this version, the side panels can selectively be hinged open in order to expand the available display space for any of the purposes described above.

Referring to FIG. 5, a display apparatus 90 made in accordance with a second preferred embodiment of the present invention is herein described. Similar parts are herein labeled with the same reference numerals for the sake of clarity.

The display apparatus 90, like the preceding, includes a stationary base 24 and a rotatably mounted support 28 that is mounted for rotation on the top of the stationary base. Also as in the preceding, the apparatus 90 further includes a top cover 32, a bottom cover 36 for the rotatable support 28, a corresponding top cover 52 and a bottom cover 56 for the stationary base 24, as well as a supporting plate (not shown) that is preferably disposed between the top cover and the interior of the support.

According to this specific embodiment, a vertically extending member 60, such as a pole, is mounted through the center axis 64 of the stationary base 24 and the support 28, the vertically extending member having a length dimension extending through the interior of each. The vertically extending member 60 is attached, as in the preceding, by means of inserts that are provided respectively, at the top and the bottom ends of the vertically extending member, end further receiving a fastener that is mounted through a supporting plate. As in the preceding, a counter weight can be added optionally to the interior of the base 24 in order to effectively balance the apparatus 90 and prevent tipping.

According to this embodiment, an electric motor 98 is disposed in the stationary base 24 and is attached by conventional means to the vertically extending member 60 at the lower end thereof such that the output drive of the motor produces rotational movement of the support 28 about its center axis 64, as shown by arrow 104 based on the support of the vertically extending member 60.

A series of electrical leads 108 are directed or routed through the hollow interior of the vertically extending member 60, the leads extending to a light source 112 that is preferably disposed atop the top cover 32 of the herein described apparatus 90. According to this embodiment, the electrical leads 108 extend through the vertically extending member 60, which is stationary. Therefore, the leads 108 are not tangled, pulled or otherwise manipulated as the support 28 is rotated under the drive force of the electric motor 98. Alternatively, the electrical leads 108 can be used to solely power the light source 112 and the user can manually rotate the support 28 to effect selective rotation of the apparatus 90, for example, using the connection brackets 47.

It should be noted herein that the sign illustrated herein is merely exemplary and it should be readily apparent that other configurations and locations for same can be similarly utilized.

Referring to FIGS. 6-8, a rotatable display apparatus made in accordance with a third embodiment of the present invention is now described.

As in the preceding, the rotatable display apparatus 140 includes a stationary base 144 and a support 148. The support 148, according to this embodiment, is substantially cubic in configuration and includes four (4) orthogonal side panels 152 as well as respective top and bottom covers 156, 160, surrounding a hollow interior. As noted in the preceding, the support 148 and base 144 can assume other geometries or configurations and can be easily varied. According to this embodiment, the base 144 is circular, though this shape can also be suitably varied, the base being defined by a unitary plastic molded section having an upper opening (not shown) sized for receiving a vertically extending member 164, shown only in FIG. 7, that further extends through the hollow interior of the support 148 through the bottom cover 160 and an intermediate panel (not shown) which is used to distribute weight. A similar intermediate panel (not shown) is provided beneath the top cover 156, each of the covers being attached by fasteners wherein the attachment of the bottom cover is more clearly shown in FIG. 8. As previously noted, the covers could be alternatively fabricated in a manner such that the intermediate panel is not required.

The orthogonally arranged side panels 152 are each fitted into lateral slots of connecting brackets 168 used in the support, the brackets being similar to those previously described, in which the slots are disposed at right angles relative to one another for receiving an edge of a side panel 152. According to this embodiment, the side panels 152 are similar to those depicted in FIGS. 9 and 10 and commonly include a planar supporting member, a frame, and a plurality of transverse strip members. The engagement portion of each strip member is fitted in a staggered manner into a spaced array of longitudinal slots provided on the planar supporting member, the strip members also being held at respective ends by frame or panel frame portions and in which a transparent cover portion of the strip member and the facing surface of the supporting member forms a pocket, permitting the display of a plurality of photographs or other graphic media in a releasable, versatile and extremely efficient manner. Further details concerning the design of the carrier panels described herein can be found in previously cross-referenced and incorporated U.S. Ser. No. 10/732,662. It will be readily apparent, however, that other types of panels, such as dry erase boards, calendar boards, magnetic boards, bulletin boards, and the like can also be suitably provided in lieu of or in addition to at least one carrier panel.

The design described herein by the present embodiment is a compact version of a rotatable display apparatus. According to this described design, the assembly 140 is approximately 26 inches in height, 19 inches in depth and 19 inches in width, enabling the apparatus to be used, for example, on a table top or similar supporting surface.

The vertical supporting member 164 is similarly attached to each of the base 144 and Support 148, as previously described with regard to FIG. 3, to enable rotation by the user. An extending handle 174 is threadingly attached to a protruding mounting bolt, similar to fastener 80, FIG. 3, but having a longer shank that extends through an opening in the top cover 156 to permit the compact display apparatus 140 to be moved as needed, thereby making the apparatus portable. As assembled herein, the present apparatus 140 is lightweight to permit movement. Because of the lower aspect ratio between the base 144 and the support 148, inclusion of a counterweight in the base is not necessary, though optional.

The herein described display apparatus 140 includes an 18″×24″ display surface on each of its four sides. Therefore, approximately 12

square feet of total display space is provided in a minimum footprint wherein the present apparatus rotates in a 23″ circle.

Parts List for FIGS. 1-10

20 rotatable display apparatus
24 base
28 support
32 top cover
36 bottom cover
40 lateral side facing panel
44 lateral side facing panel
47 connecting brackets
48 unitary member
49 slots
50 inwardly cupped portion
52 top cover
56 bottom cover
60 vertically extending member
64 center axis
66 intermediate top panel
70 opening
74 intermediate lower panel
78 transparent plastic sleeves
80 fastener
81 head
82 fastener
84 nut
85 nut
86 washer
88 insert
89 nylon washer
90 display apparatus
93 nut
95 washer
97 counterweight
98 motor
99 flat head screws
100 fastener
102 threaded T-nuts
104 arrow
108 electrical leads
112 light source
140 rotatable display apparatus
144 base
148 support
152 side panels
156 top cover
160 bottom cover
164 vertically extending member
168 connecting brackets
174 handle
200 carrier panel
204 planar supporting member
208 frame
212 transverse strip members
216 photographs
218 upper facing surface
220 longitudinal slots
224 supporting or engagement portion
228 cover portion
232 edge
236 edge
240 frame member
242 frame member
244 frame member
246 frame member
250 receiving slot

It will be readily apparent that there are many modifications and variations that are possible encompassing the spirit and the scope of the present invention as now recited by the following claims. For example and though not shown, support for the side facing panels could be provided by the vertically extending member. That is, the vertically extending member can include at least one core section having a square, round or other shape that permits direct attachment of at least one facing display panel. Moreover, the panels can be selectively releasable from the at least one core section. According to another variation, the core section can include an interior component and an exterior component that permits rotation relative to the interior component, the vertically extending member still allowing electrical leads to be routed through the interior component thereof. In yet another variation, the vertically extending sections can be utilized to receive additional componentry, for example, other types of handles or other means accessible to the user to facilitate rotation of the display apparatus.

1. A compact display apparatus comprising:
a base;
a support rotatably mounted to a top surface of said base, said compact display apparatus being sized to permit said apparatus to be used on a table-top.

2. A display apparatus as recited in claim 1, including means for permitting said support to be rotated about a center axis of said display apparatus, wherein said rotation means includes at least one vertically extending member disposed through the interior of each of said support and said base.

3. A display apparatus as recited in claim 2, wherein said at least one vertically extending member includes means for permitting electrical leads to be routed therethrough.

4. A display apparatus as recited in claim 3, wherein said at least one vertically extending member is hollow.

5. A display apparatus as recited in claim 3, wherein said at least one vertically extending member includes an axial slot sized for receiving said electrical leads.

6. A display apparatus as recited in claim 3, including at least one light source connected to electrical leads routed through said pole.

7. A display apparatus as recited in claim 1, including at least one electric motor.

8. A display apparatus as recited in claim 7, wherein at least one electric motor is disposed in said base.

9. A display apparatus as recited in claim 1, wherein said base is circular.

10. A display apparatus as recited in claim 9, wherein said base is formed from a durable plastic.

11. A display apparatus as recited in claim 1, wherein said support includes at least one lateral panel attached thereto.

12. A display apparatus as recited in claim 11, wherein said at least one lateral panel includes means for displaying a plurality of graphic media articles.

13. A display apparatus as recited in claim 12, wherein said graphic media article displaying means includes a planar supporting member and a corresponding plurality of strip members, each of said strip members including an engagement portion for attaching to said planar supporting member and a cover portion for supporting graphic media.

14. A display apparatus as recited in claim 13, wherein at least the cover portions of said strip members are transparent.

15. A display apparatus as recited in claim 14, wherein said planar supporting member includes a plurality of parallel longitudinal slots, said engagement portions of said strip members being engageable with a said slot to secure said strip member therein.

16. A display apparatus as recited in claim 15, wherein said slots are in spaced relation to one another, such that each of said strip members provide pockets for permitting graphic media items to be added.

17. A display apparatus as recited in claim 16, wherein said support is polyhedral, said support including at least two panels having said graphic media displaying means.

18. A display apparatus as recited in claim 11, wherein said support includes a plurality of lateral panels.

19. A display apparatus as recited in claim 17, wherein said support is formed in a substantially cubic configuration.

20. A display apparatus as recited in claim 18, wherein said plurality of display panels includes at least one of a white dry-erase board, a calendar board, a bulletin board and a magnetic board.

21. A display apparatus as recited in claim 1, including a handle to permit said apparatus to be carried between locations.
